(19) United States
(12) Patent Application Publication
(10) Pub. No.: US 2010/0153851 A1
(43) Pub. Date: Jun. 17, 2010

(54) RENDERING RSS SUBSCRIPTIONS ON A CALENDAR

(75) Inventors: Andrew John Sullivan, Seattle, WA (US); Allie Bellew, Seattle, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/333,464

(22) Filed: Dec. 12, 2008

(51) Int. Cl. G06F 3/048

(52) U.S. Cl. 715/733

(57) ABSTRACT

Rendering RSS subscriptions on a calendar may be provided. First, an RSS feed may be received by an RSS client. The RSS feed may contain a data item associated with an event date. A recipient computer running an electronic calendar program may display the received data item on the surface of an electronic calendar. The data item may be displayed in the location on the electronic calendar representing the event date. Periodically, new content may be downloaded from the RSS feed and used to update the displayed data items. The RSS client may also handle data related to the scheduling functions of the electronic calendar. Displaying the received data item may comprise displaying a graphical icon contained within the received data item wherein the graphical icon is a visual representation of an event represented by the data item.

### BACKGROUND

Rich Site Summary (“RSS”) feeds may be received over a network to provide information relating to any number of subjects. Often times an RSS feed may contain data that is related to a particular date, or sometimes a particular time on a date. This data is currently rendered in an RSS reader. The RSS reader in current systems displays the data as items sorted based on the time that the items were posted to the RSS feed. However, this manner of displaying RSS items does not take advantage of valuable event date information contained within the data.

### SUMMARY

This summary is provided to introduce a selection of concepts in a simplified form that are further described below in the Detailed Description. This summary is not intended to identify key features or essential features of the claimed subject matter, nor is it intended to be used to limit the claimed subject matter's scope.

Rendering RSS subscriptions on a calendar may be provided. First, an RSS feed may be received by an RSS client. The RSS feed may contain a data item associated with an event date. A recipient computer running an electronic calendar program may display the received data item on the surface of an electronic calendar. The data item may be displayed in the location on the electronic calendar representing the event date. Periodically, new content may be downloaded from the RSS feed and used to update the displayed data items. The RSS client may also handle data related to the scheduling functions of the electronic calendar. The received data item may contain the event date in a pre-formatted data field within the data item. Alternatively, the event date may be inferred from other information in the received data item. Displaying the received data item may comprise displaying a graphical icon contained within the received data item wherein the graphical icon is a visual representation of an event represented by the data item. The location on the electronic calendar where the graphical icon is displayed may be pre-determined by a user.

Both the foregoing general description and the following detailed description provide examples and are explanatory only. Accordingly, the foregoing general description and the followed detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of an operating environment;

FIG. 2 is a flow chart of a method for rendering RSS subscriptions to an electronic calendar;

FIG. 3A is a screen shot of a rendered RSS subscription;

FIG. 3B is a screen shot of a rendered RSS subscription; and

FIG. 4 is a block diagram of a system including a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

The rendering of RSS subscriptions to an electronic calendar may be provided. Consistent with embodiments of the present invention, RSS feeds may be rendered differently from appointments or meetings on the electronic calendar as to avoid interference with a user's scheduling features. Events contained within RSS data may be displayed such that appropriate information is displayed to the user in appropriate date/time locations on the electronic calendar. Certain fields in the RSS feed may be used to determine where on the electronic calendar to place the data. The data rendered may include images, text, or any other type of information that may be visualized.

An RSS client that also handles data related to an electronic calendar may be provided. Either the RSS feed can specify the date and time for each data item or the date and time data may be inferred from other properties of the feed. A user may select a portion of the electronic calendar surface to be used when displaying data items. The data items displayed on the electronic calendar may be updated whenever the RSS client downloads new content from the RSS feed.

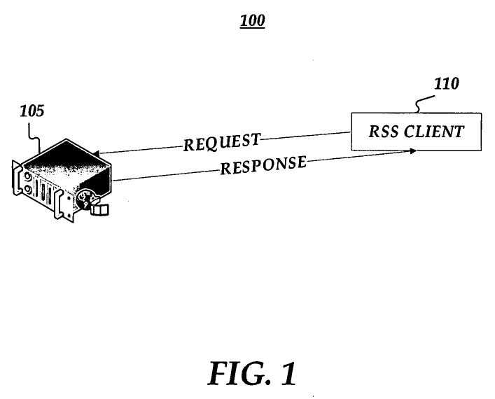

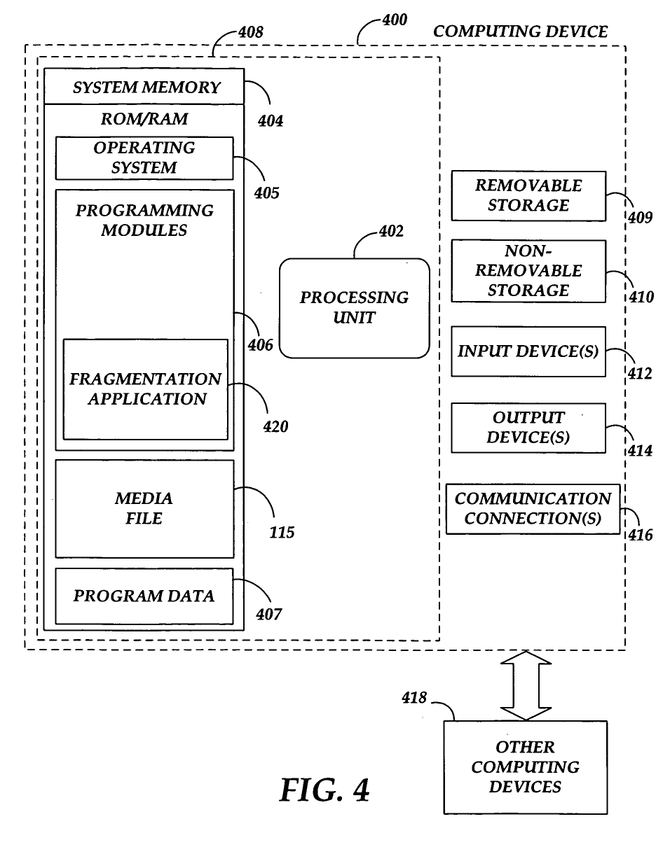

FIG. 1 is a block diagram of an operating environment including a RSS rendering system 100. RSS rendering system 100 may include a server 105 and an RSS client 110. RSS client 110 may be operated by a user wishing to receive an RSS feed. RSS client 110 may also handle data relating to the scheduling functions of an electronic calendar. Server 105 may provide the RSS data to RSS client 110. Server 105 may be implemented using a computing device 400 and RSS client may be implemented using other computing devices 418 as described in more detail below in FIG. 4.

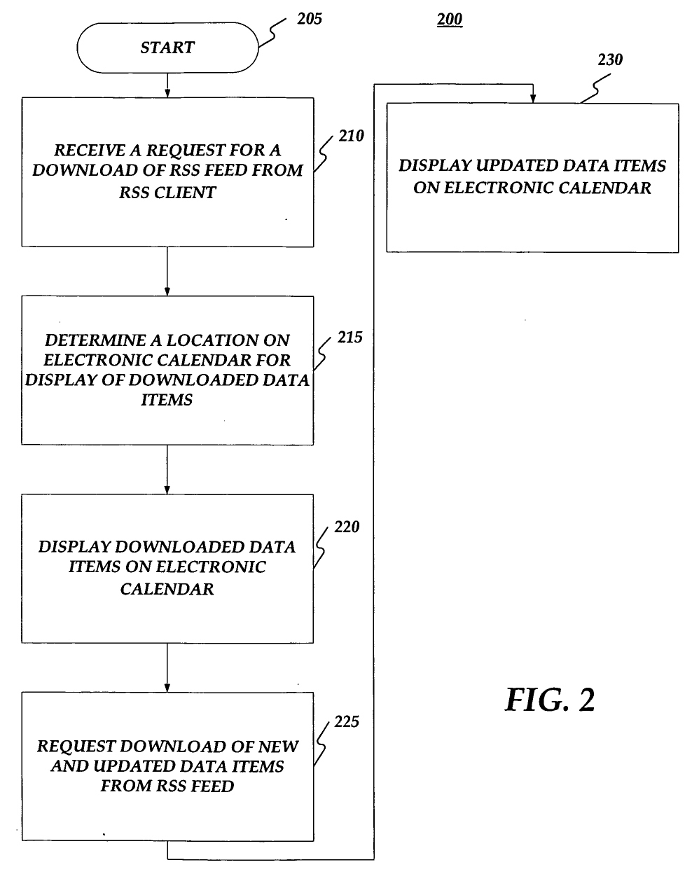

FIG. 2 is a flow chart setting forth the general stages involved in a method 200 consistent with embodiments of the invention for rendering RSS subscriptions to an electronic calendar. Method 200 may be implemented using server 105 and RSS client 110, as described above. Ways to implement the stages of method 200 will be described in greater detail below.

Method 200 may begin at starting block 205 and proceed to stage 210 where server 105 may receive a request from RSS client 110 to download data items contained in an RSS feed. In some cases, the RSS feed may be a service that a user subscribed to in order to receive data items relating to a particular subject. From stage 210, where RSS client 110 receives an RSS feed containing data items associated with event dates, method 200 may advance to stage 215.

At stage 215, a location on an electronic calendar for display of received data items may be determined by a user. For example, the user may use the user's electronic calendar primarily in a view where one week of individual days are represented. Each day may be represented by a block of space located within the week display. The user may wish to have received data items displayed at the bottom of the day blocks as to not interfere with a normal electronic calendar usage of the top of each day block to display other information.

From stage 215, method 200 may advance to stage 220, where a data item received by RSS client 110 may be displayed on the surface of an electronic calendar. The data item may be displayed at a location on the electronic calendar indicative of the event date associated with the data item. For example, the data item may contain a pre-formatted data field designed to hold date-formatted information. Thus, RSS client 110 may determine the event date by locating the pre-formatted data field. The event date may be inferred from the received data item. For example, the data item may be parsed to search for relevant event date information.

At stage 220, the data item may contain a graphical icon that may be displayed at a location on the electronic calendar indicative of the event date associated with the data item. This graphical icon may be a visual representation of an event represented by the data item. For example, the data item may be weather information associated with a particular date. The data item may contain a graphical icon (i.e., graphical representation of the sun) that may be displayed with or in place of the remaining data associated with the data item on the calendar location associated with the date the weather is for.

Furthermore, from stage 220, method 200 may advance to stage 225. At stage 225, the RSS client may request the downloading of new content items from the RSS feed. Method 200 may then advance to stage 230 where it is determined if some of the new content items update the information in currently displayed data items. If it is determined that a new content items updates a currently displayed data item, the currently displayed data item may be updated accordingly.

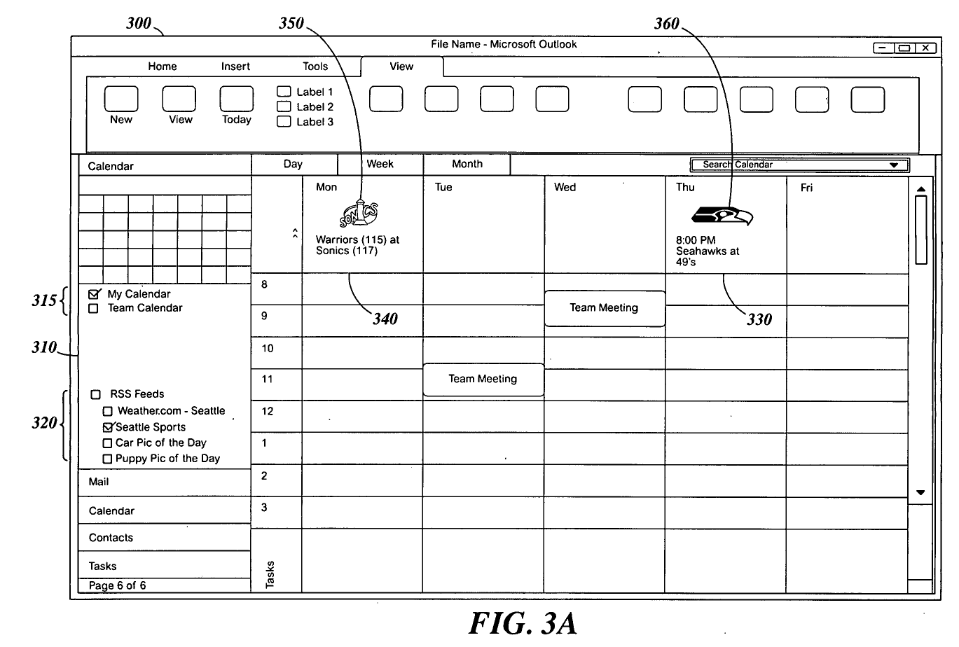

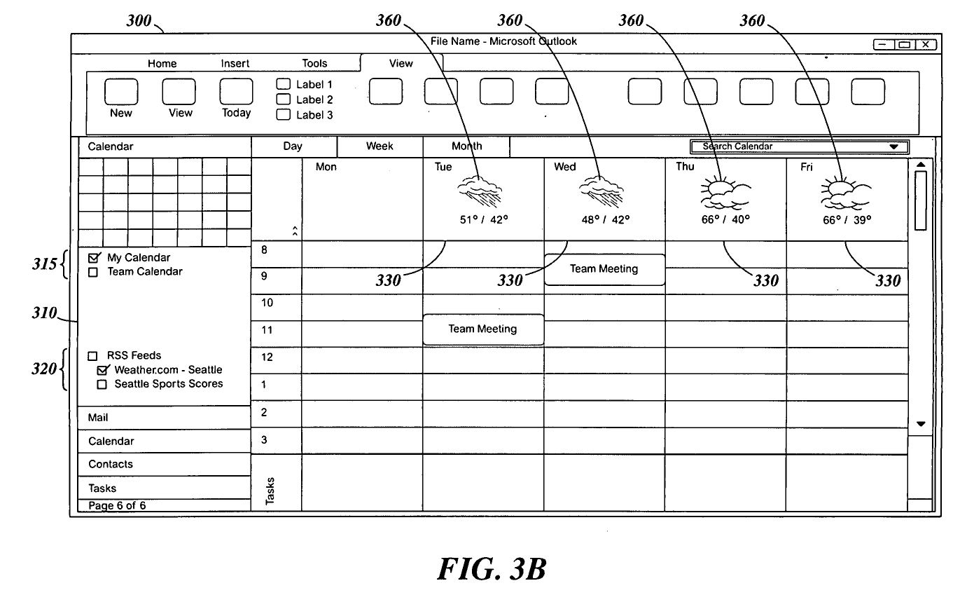

FIG. 3A is a screen shot of a rendered RSS subscription on an electronic calendar 300. Electronic calendar 300 may be any program used to store and display events on the dates associated with the events. Electronic calendar 300 may include a side window 310. Side window 310 may list a directory structure of available calendar layouts 315. In this illustration, available calendar layouts 315 may include a default calendar (“My Calendar”) and a more sporting event specific calendar (“Team Calendar”). The types of calendar layouts 315 are in no way limited by this example and may include any number of pre-prepared or customized layouts.

Side window 310 also may list a directory structure of available RSS feeds 320. In this case, the user has selected the available RSS feed 320 (“Seattle Sports”) out of four RSS feeds 320 that user has subscribed to. A user may select one or more RSS feeds 320 for display on the surface of electronic calendar 300. In this case, selected RSS feed 320 has received two data items 330, 340 displayed on the representation of their event dates within electronic calendar 300.

Data item 330 may at least contains information including an event description and a graphical icon 360 representing the event. The event date (Thursday) may have been inferred from data item 330, that in turn determines the proper location to display data item 330 based on the inferred event date. Similarly, data item 340 may at least contain information including an event description and a graphical icon 350 representing the event. Data item 340 may contain a pre-formatted data field that contains the event date and time information.

FIG. 3B illustrates a screen shot of a rendered RSS subscription to a weather feed on electronic calendar 300. Electronic calendar 300 may be any program used to store and display events on the dates associated with the events. Electronic calendar 300 may include a side window 310. Side window 310 may list a directory structure of available calendar layouts 315. In this illustration the available calendar layouts 315 may be identical to those illustrated in FIG. 3a. The types of calendar layouts 315 are in no way limited by this example and may include any number of pre-prepared or customized layouts.

Side window 310 also may list a directory structure of available RSS feeds 320. In this case, the user may have selected available RSS feed 320 (“Weather.com-Seattle”) out of four RSS feeds 320 that user has subscribed to. In this example, RSS feed 320 may provide daily weather forecast information. In this case, selected RSS feed 320 may receive a daily data item 330 displayed on the representation of their event dates within electronic calendar 300. Data item 330 may contain a graphical icon 360 that may be representative of the data item (i.e., forecast). One or more data items 330 may be updated when RSS client 110 downloads updated data items 330 with updated associated graphical icon 360.

FIG. 4 is a block diagram of a system including computing device 400. Consistent with an embodiment of the invention, the aforementioned memory storage and processing unit may be implemented in a computing device, such as computing device 400 of FIG. 4. Any suitable combination of hardware, software, or firmware may be used to implement the memory storage and processing unit. For example, the memory storage and processing unit may be implemented with computing device 400 or any of other computing devices 418 (e.g. RSS client 110), in combination with computing device 400. The aforementioned system, device, and processors are examples and other systems, devices, and processors may comprise the aforementioned memory storage and processing unit, consistent with embodiments of the invention.

With reference to FIG. 4, a system consistent with an embodiment of the invention may include a computing device, such as computing device 400. In a basic configuration, computing device 400 may include at least one processing unit 402 and a system memory 404. Depending on the configuration and type of computing device, system memory 404 may comprise, but is not limited to, volatile (e.g. random access memory (RAM)), non-volatile (e.g. read-only memory (ROM)), flash memory, or any combination. System memory 404 may include operating 407. Operating system 405, for example, may be suitable for controlling computing device 400's operation. In one embodiment, programming modules 406 may include, for example a fragmentation application 420. Furthermore, embodiments of the invention may be practiced in conjunction with a graphics library, other operating systems, or any other application program and is not limited to any particular application or system. This basic configuration is illustrated in FIG. 4 by those components within a dashed line 408.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium that can be used to store information and that can be accessed by computing device 400. Any such computer storage media may be part of device 400. Computing device 400 may also have input device(s) 412 such as a keyboard, a mouse, a pen, a sound input device, a touch input device, etc. Output device(s) 414 such as a display, speakers, a printer, etc. may also be included. The aforementioned devices are examples and others may be used.

Computing device 400 may also contain a communication connection 416 that may allow device 400 to communicate with other computing devices 418, such as over a network in a distributed computing environment, for example, an intranet or the Internet. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 404, including operating system 405. While executing on processing unit 402, programming modules 406 (e.g. fragmentation application 420) may perform processes including, for example, one or more method 200's stages as described above. The aforementioned process is an example, and processing unit 402 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Hash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method of rendering Rich Site Summary (RSS) feeds comprising:
receiving an RSS feed with an RSS client wherein the RSS feed contains a data item associated with an event date; and
displaying the received data item on the surface of an electronic calendar, wherein the received data item is displayed in a location on the electronic calendar representing the event date.

2. The method of claim 1, wherein receiving the RSS feed with the RSS client comprises receiving the RSS feed wherein the RSS client also handles data related to the scheduling functions of the electronic calendar.

3. The method of claim 1, wherein receiving the RSS feed with the RSS client comprises receiving the RSS feed wherein the event date is inferred from the received data item.

4. The method of claim 1, further comprising:
downloading new content from the RSS feed;
updating the displayed data items with the downloaded new content.

5. The method of claim 1, wherein receiving the RSS feed with the RSS client comprises receiving the RSS feed wherein the received data item contains the event date and time in a pre-formatted data field within the data item.

6. The method of claim 1, wherein displaying the received data item further comprises displaying a graphical icon contained within the received data item, wherein the displayed graphical icon is a visual representation of an event represented by the data item.

7. The method of claim 6, wherein displaying the graphical icon comprises displaying the graphical icon in a location on the electronic calendar pre-determined by a user.

8. A computer-readable medium which stores a set of instructions which when executed performs a method for processing Rich Site Summary (RSS) feeds, the method executed by the set of instructions comprising:
receiving an RSS feed with an RSS client wherein the RSS feed contains a data item associated with an event date;
inferring the event date from the received data item; and
displaying the received data item on the surface of an electronic calendar, wherein the data item is displayed in a location on the electronic calendar representing the event date.

9. The computer-readable medium of claim 8, wherein the RSS client also handles data related to the scheduling functions of the electronic calendar.

10. The computer-readable medium of claim 8, wherein the data item includes weather information.

11. The computer-readable medium of claim 8, further comprising:
downloading new content from the RSS feed;
updating the displayed data items with the downloaded new content.

12. The computer-readable medium of claim 8, wherein the received data item contains the event date and time in a pre-formatted data field within the data item.

13. The computer-readable medium of claim 8, wherein displaying the received data item further comprises displaying a graphical icon contained within the received data item, wherein the displayed graphical icon is a visual representation of an event wherein the graphical icon displays the event and time.

14. The computer-readable medium of claim 13, wherein the graphical icon is displayed in a location on the electronic calendar pre-determined by a user.

15. A system for processing Rich Site Summary feeds, the system comprising:
a memory storage;
a processing unit coupled to the memory storage, wherein the processing unit is operative to:
receive an RSS feed with an RSS client wherein the RSS feed contains a data item associated with an event date;
display the received data item on the surface of an electronic calendar, wherein the data item is displayed in the location on the electronic calendar representing the event date.

16. The system for processing RSS feeds of claim 15, wherein the RSS client also handles data related to the scheduling functions of the electronic calendar.

17. The system for processing RSS feeds of claim 15, wherein the event date and time are inferred from the received data item.

18. The system for processing RSS feeds of claim 15, wherein the processing unit is operative to:
download new content from the RSS feed; and
update the displayed data items with the downloaded new content.

19. The system for processing RSS feeds of claim 15, wherein the processing unit being operative to display the received data item comprises the processing unit being operative to display a graphical icon contained within the received data item, wherein the displayed graphical icon is a visual representation of an event represented by the data item.

20. The system for processing RSS feeds of claim 19, wherein the graphical icon is displayed in a location on the electronic calendar pre-determined by a user.
